(19) United States
(12) Patent Application Publication
(10) Pub. No.: US 2009/0125837 A1
(43) Pub. Date: May 14, 2009

(54) TAB CONTROL WITH TYPE AHEAD AND THUMBNAIL IMAGES

(75) Inventors: Matthew T. Hatem, Portsmouth, NH (US); Martin T. Moore, Somerville, MA (US); Mary E. Raven, Merrimack, NH (US); Terrence Smith, Rumford, RI (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/937,409

(22) Filed: Nov. 8, 2007

(51) Int. Cl. G06F 3/048

(52) U.S. Cl. 715/788

(57) ABSTRACT

Embodiments of the present invention address deficiencies of the art in respect to tab control presentation and provide a method, system and computer program product for tab control management with type-ahead and thumbnail imagery. In an embodiment of the invention, a tab control navigation method can be provided. The method can include arranging thumbnail images for corresponding tabs in a tab control within a tab navigation view, and, in response to a selection of one of the thumbnail images, activating a corresponding one of the tabs in the tab control. The method further can include receiving text in a type-ahead filter, and filtering the tab navigation view to include only thumbnail images corresponding to tabs associated with the text.

### BACKGROUND OF THE INVENTION

1. Field of the Invention

The present invention relates to the field of user interface control management and more particularly to tab control resizing in a user interface.

2. Description of the Related Art

The conventional graphical user interface (GUI) has been widely used for many years. The primary function of the GUI includes providing visual controls with which the end-user can interact with an underlying application. Though the common GUI includes many stock visual controls, a select few visual controls can be combined to accommodate most computer-human interactions required by an application. For example, the static text box control can be used to present text to the end-user while an edit box can permit the user to provide textual input to the application. A radio button control can provide for the exclusive selection of an element from among a field of elements, while a checklist box can control can provide for the non-exclusive selection of elements from among a field of elements.

User interface controls ordinarily provide a visual interface which permits some sort of user interactivity, such as a mouse click for a button or check box, and an insert caret for a text field. While a textual label ordinarily is associated with the control as a separate component, the textual label for the control and the control itself often are viewed as a singular entity. As such, the combination of the textual label and the control provide two basic informational components: the identity of the control and the immediate state of the control, e.g. selected, input provided, etc. Notably, over the years, the basic idea of the user interface control has not changed, despite increases in the expressive power of other aspects of the GUI.

Certain types of a GUI controls can produce clutter in a view due to the separate nature of the label and control. In particular, where the label for the control exceeds the width of the control itself, a limited number of controls can be placed adjacent to one another in a view while maintaining an orderly appearance. Also, the distance between each control can increase as the width of the label far exceeds that of the control. In many cases, groups of controls are arranged together such as an arrangement of radio buttons grouped together to provide a singular choice among the choices corresponding to the radio buttons. In this case, it can be important to arrange the controls close enough together to indicate that a user is to choose one radio button from amongst the arrangement of radio buttons.

Tabbed portions of a GUI address the problem of GUI clutter by providing a third-dimension to a two-dimensional portion of a GUI. The third-dimension incorporates different views to the same two-dimensional portion of the GUI in which each view can be accessed through the selection of a corresponding tab control much in the same way that a tabbed filing cabinets provides ease of access to different papers in a file without requiring each paper to remain in plain view in the filing cabinet. In this way, the two-dimensional portion of the GUI, with respect to the GUI can be minimized to provide a clutter-free environment.

Tabbed portions of a GUI can be most effective with a limited number of tabs. As more tabs are added to a tab control, the width of each tab compresses along with descriptive text provided in each tab. Once each tab has compressed substantially, it is difficult for an end-user to determine which content is associated with which tab thereby defeating the purpose of the tab control. Notably, as tabs are added to a tab control, generally, each of the tabs for the tab control shrink equidistantly. Consequently, no one tab is favored over another and the text in each tab will become obscured uniformly.

### BRIEF SUMMARY OF THE INVENTION

Embodiments of the present invention address deficiencies of the art in respect to tab control presentation and provide a novel and non-obvious method, system and computer program product for tab control management with type-ahead and thumbnail imagery. In an embodiment of the invention, a tab control navigation method can be provided. The method can include arranging thumbnail images for corresponding tabs in a tab control within a tab navigation view, and, in response to a selection of one of the thumbnail images, activating a corresponding one of the tabs in the tab control. The method further can include receiving text in a type-ahead filter, and filtering the tab navigation view to include only thumbnail images corresponding to tabs associated with the text.

Optionally, in an aspect of the embodiment, the method further can include repeatedly filtering the tab navigation view to include only thumbnail images corresponding to tabs associated with the text as the text changes in the type-ahead filter. In another aspect of the embodiment, arranging thumbnail images for corresponding tabs in a tab control within a tab navigation view can include arranging thumbnail images for corresponding tabs in a tab control within a tab navigation view in a tab navigation element as an additional tab in the tab control. In yet another aspect of the embodiment, filtering the tab navigation view to include only thumbnail images corresponding to tabs associated with the text can include filtering the tab navigation view to include only thumbnail images corresponding to tabs having a title containing the text. Alternatively, in even yet another aspect of the embodiment, filtering the tab navigation view to include only thumbnail images corresponding to tabs associated with the text can include filtering the tab navigation view to include only thumbnail images corresponding to tabs having a description containing the text.

In another embodiment of the invention, a graphical user interface data processing system can be provided. The system can include a graphical user interface for an application executing in a computer system, a tab control rendered within the graphical user interface, the tab control including tabs, and a tab navigation element coupled to the tab control. The element can include a tab navigation view including thumbnail images, each of the images corresponding to a tab in the tab control, and each of the images being selectable to activate a corresponding one of the tabs in the tab control. The tab navigation element also can include a type-ahead filter configured to accept text and to filter the thumbnail images in the tab navigation view responsive to the text. Finally, the tab navigation element can be disposed in a tab in the tab control.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a tab control configured with type-ahead and thumbnail imagery;

FIG. 2 is a schematic illustration of a GUI data processing system configured for tab control management with type-ahead and thumbnail imagery; and,

FIG. 3 is a flow chart illustrating a process for tab control management with type-ahead and thumbnail imagery.

### DETAILED DESCRIPTION OF THE INVENTION

Embodiments of the present invention provide a method, system and computer program product for tab control management with type-ahead and thumbnail imagery. In accordance with an embodiment of the present invention, thumbnail images of tab content for tabs in a tab control can be organized in a single display. Additionally, the tab content can be filtered in a type-ahead filter to a subset of thumbnail images through the entry of text matching a description of the tab content. Responsive to the selection of one of the thumbnail images, the tab content for the selected one of thumbnail images can be rendered active in the tab control. In this way, the clutter of a multiplicity of tabs in the tab control can be managed in a single user interface.

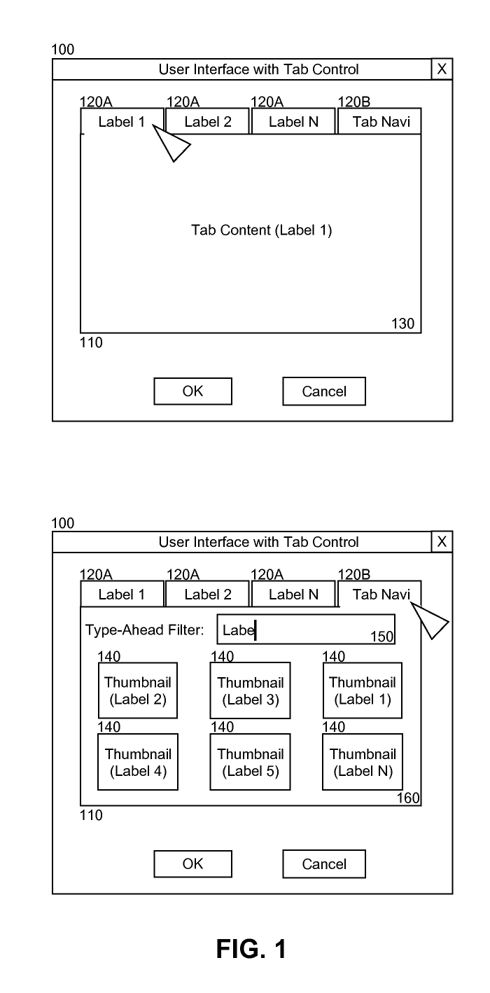

In illustration, FIG. 1 pictorially depicts a tab control configured with type-ahead and thumbnail imagery. As shown in FIG. 1, a graphical user interface 100 can be provided with a tab control 110. The tab control 110 can include multiple different tabs 120A, each providing a view upon selection of corresponding tab content 130. It will be recognized that the number of tabs 120A able to display a view to a textual description of corresponding tab content 130 can be limited by the physical dimensions of the tab control 110 which can be dependent upon the physical dimensions of the graphical user interface 100. In consequence, a tab navigation element 120B can be provided in connection with the tab control 110.

Specifically, the tab navigation element 120B when selected can provide a tab navigation view 160 to thumbnail images 140 for each of the tabs 120A. The thumbnail images 140 can include, for example, imagery of a portion or the entirety of the tab content 130 for a corresponding one of the tabs 120A. Each thumbnail image 140 can be activatable such that the activation of a given thumbnail image 140 results in the activation of a corresponding one of the tabs 120A in the tab control 110. Notably, a type-ahead filter 150 can be provided in the tab navigation view 160. The type-ahead filter 150 can accept text input in response to which the tab navigation element 120B can filter the thumbnail images 140 shown in the tab navigation view 160 to those corresponding tabs 120 incorporating the text in the type-ahead filter 150. Additionally, the filtering can be repeated for each character entered in the type-ahead filter 150.

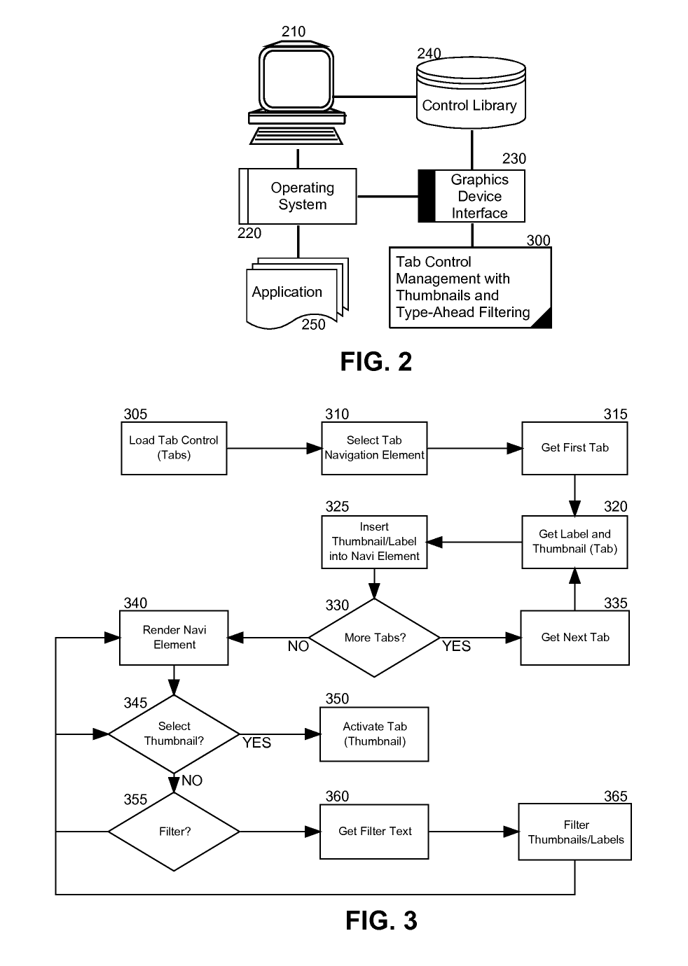

The tab control 110 shown in FIG. 1 can be embodied within a GUI data processing system. In this regard, FIG. 2 is a schematic illustration of a GUI data processing system configured for tab control management with type-ahead and thumbnail imagery. The system can include a host computing platform 210 supporting the operation of an operating system 220. The operating system 220 can include a graphics device interface 230 coupled to a control library 240. Specifically, the graphics device interface 230 can provide a programmatic interface to the control library 240 including windows, dialog boxes, buttons, text fields, and tab controls, to name only a few.

The operating system 220 can host one or more applications 250 and each of the applications 250 can provide a user interface with the assistance of the graphics device interface 230. Importantly, tab control management logic 300 can be coupled to the graphics device interface 230. In particular, the tab control management logic 300 can be incorporated as part of the operation system 220, the graphics device interface 230, or as part of any of the applications 250 accessing the control library 240 through the graphics device interface 230.

The tab control management logic 300 can include program code enabled to arrange a tab navigation view with thumbnails each corresponding to the content of an associated tab in a tab control. The program code of the tab control management logic 300 further can be enabled to activate a tab in the tab control corresponding to a selected one of the thumbnail images in the tab navigation view. Finally, the program code of the tab control management logic 300 can be enabled to filter the thumbnail images according to text provided in a type-ahead filter. The filtering action of the program code of the tab control management logic 300 can be continuous in response to each character provided in the type-ahead filter and the filter itself can limit the thumbnail images in the tab navigation view to thumbnail images associated with tabs each having a description or title containing the text in the type-ahead filter.

In yet further illustration of the operation of the tab control management logic 300, FIG. 3 is a flow chart illustrating a process for tab control management with type-ahead and thumbnail imagery. Beginning in block 305, a tab control of multiple different tabs in a graphical user interface for an application can be loaded and in block 310 a tab navigation element for the tab control can be selected for processing. In block 315 a first tab in the tab control can be selected and in block 320 a label and thumbnail for the tab can be determined. Thereafter, in block 325 the thumbnail and label can be inserted into a tab navigation view for the tab navigation element.

In decision block 330, if additional tabs remain to be processed, in block 335 a next tab can be retrieved and the process can continue through block 320. The process can repeat for each tab in the tab control until no tabs remain to be processed in decision block 330. Subsequently, in block 340 the tab navigation element can be rendered either separately from the tab control, for instance as a pop-up window or a drop down list from a tool bar or menu, or as part of the tab control, for instance as an additional tab in the tab control.

In decision block 345, it can be determined whether or not a thumbnail image in the tab navigation view of the tab navigation element has been selected. If so, in block 350 a tab in the tab control corresponding to the selected thumbnail image can be activated. Otherwise, in decision block 355 it can be determined whether one or more characters of text have been provided in a type-ahead filter for the tab navigation element. If so, in block 360 the provided text can be retrieved and the thumbnails in the tab navigation view can be filtered in block 365 to only those thumbnail images associated with tabs having a title or description containing the provided text. In this way, the end user can more easily identify which tab is desired for selection—particularly where the tab control contains a multiplicity of tabs.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A tab control navigation method comprising:
arranging a plurality of thumbnail images for corresponding tabs in a tab control within a tab navigation view;
responsive to a selection of one of the thumbnail images, activating a corresponding one of the tabs in the tab control;
receiving text in a type-ahead filter; and,
filtering the tab navigation view to include only thumbnail images corresponding to tabs associated with the text.

2. The method of claim 1, further comprising repeatedly filtering the tab navigation view to include only thumbnail images corresponding to tabs associated with the text as the text changes in the type-ahead filter.

3. The method of claim 1, wherein arranging a plurality of thumbnail images for corresponding tabs in a tab control within a tab navigation view, comprises arranging a plurality of thumbnail images for corresponding tabs in a tab control within a tab navigation view in a tab navigation element as an additional tab in the tab control

4. The method of claim 1, wherein filtering the tab navigation view to include only thumbnail images corresponding to tabs associated with the text, comprises filtering the tab navigation view to include only thumbnail images corresponding to tabs having a title containing the text.

5. The method of claim 1, wherein filtering the tab navigation view to include only thumbnail images corresponding to tabs associated with the text, comprises filtering the tab navigation view to include only thumbnail images corresponding to tabs having a description containing the text.

6. A graphical user interface data processing system comprising:
a graphical user interface for an application executing in a computer system;
a tab control rendered within the graphical user interface, the tab control comprising a plurality of tabs; and,
a tab navigation element coupled to the tab control, the element comprising a tab navigation view comprising a plurality of thumbnail images, each of the images corresponding to a tab in the tab control, each of the images being selectable to activate a corresponding one of the tabs in the tab control, the tab navigation element further comprising a type-ahead filter configured to accept text and to filter the thumbnail images in the tab navigation view responsive to the text.

7. The system of claim 6, wherein the tab navigation element is disposed in a tab in the tab control.

8. A computer program product comprising a computer usable medium embodying computer usable program code for tab control navigation, the computer program product comprising:
computer usable program code for arranging a plurality of thumbnail images for corresponding tabs in a tab control within a tab navigation view;
computer usable program code for responsive to a selection of one of the thumbnail images, activating a corresponding one of the tabs in the tab control;
computer usable program code for receiving text in a type-ahead filter; and,
computer usable program code for filtering the tab navigation view to include only thumbnail images corresponding to tabs associated with the text.

9. The computer program product of claim 8, further comprising computer usable program code for repeatedly filtering the tab navigation view to include only thumbnail images corresponding to tabs associated with the text as the text changes in the type-ahead filter.

10. The computer program product of claim 8, wherein the computer usable program code for arranging a plurality of thumbnail images for corresponding tabs in a tab control within a tab navigation view, comprises computer usable program code for arranging a plurality of thumbnail images for corresponding tabs in a tab control within a tab navigation view in a tab navigation element as an additional tab in the tab control

11. The computer program product of claim 8, wherein the computer usable program code for filtering the tab navigation view to include only thumbnail images corresponding to tabs associated with the text, comprises computer usable program code for filtering the tab navigation view to include only thumbnail images corresponding to tabs having a title containing the text.

12. The computer program product of claim 8, wherein the computer usable program code for filtering the tab navigation view to include only thumbnail images corresponding to tabs associated with the text, comprises computer usable program code for filtering the tab navigation view to include only thumbnail images corresponding to tabs having a description containing the text.
